(19) United States
(12) Patent Application Publication
(10) Pub. No.: US 2006/0085737 A1
(43) Pub. Date: Apr. 20, 2006

(54) Adaptive compression scheme

(75) Inventor: Zhigang Liu, Coppell, TX (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/994,654

(22) Filed: Nov. 23, 2004

Related U.S. Application Data
(60) Provisional application No. 60/618,995, filed on Oct. 18, 2004.

(51) Int. Cl. G06F 17/24; G06F 17/21

(52) U.S. Cl. 715/513

(57) ABSTRACT

An apparatus and method of compressing a structured document. The structured document is searched once for first and second marks, a first mark indicating a start of an element of the structured document, and a second mark indicating an end of an element of the structured document. When encountering a first mark in the searching step, a representation of the first mark is output and a level counter is incremented, a value of the level counter indicating on which level in the structured document an element is located. When encountering a second mark in the searching step, a second code data is output and the level counter is decremented.

### FIELD OF THE INVENTION

The present invention relates to a method and an apparatus for compressing a structured document, e.g. an XML (eXtensible Markup Language) or HTML (HyperText Markup Language) document.

### BACKGROUND OF THE INVENTION

As an example of a Markup Language, XML is an important technique for presentation, exchange and management of data. In particular, it becomes a key building component for Internet services and applications.

XML is very powerful and flexible in terms of describing data. However, a drawback is its verbosity. That is due to the markup (e.g. tags) present in an XML document. While this is the necessary price paid for the virtues of XML such as simplicity and flexibility, it also means larger storage space, more network resource, and longer transmission delay for XML documents. This may be particularly problematic for Web services/applications in mobile environments, e.g. a mobile device that has limited storage and is connected to the Internet over a bandwidth-limited connection.

Data compression has been used to address the verbosity problem. Both generic and XML specific compression algorithms have been presented in the literature (to be described below). However, they have limitations.

In the following a short introduction for the logical structure of XML documents is given. An XML document contains one or more elements. Each element starts with a start-tag and ends with an end-tag. The name in the start- and end-tag gives the type of the element. The start-tag may contain attribute specifications of the element, in the form of attribute name and value pairs. The text between the start-tag and end-tag is the content of the element, which could be character data or another element. In this way, all the elements in an XML document logically forms a tree, with exactly one root element for each document. There is also a special type of elements that have no content. They are called empty elements. Besides the regular format aforementioned, an empty element can also be represented with a special empty-element tag (i.e. without the separate start- and end-tag). Besides start- and end-tags, there may be other markup in an XML document such as comments, processing instructions, CDATA sections, document type declarations, XML declarations, etc.

FIG. 6 shows an example of the general structure of an XML document. As shown in FIG. 6, an XML document contains elements each of which is marked with a start-tag and an end-tag, between which is the content of the element. For example, <CATALOG> and </CATALOG> are the start-tag and end-tag of the element CATALOG. An element may contain other elements, which are called “nested”, “embedded” or “children” elements. For example, element CATALOG contains many elements CD as its children.

XML documents can be compressed using generic data compression algorithms (hereafter referred to as generic algorithms), such as LZ (Ziv and Lempel) family of algorithms. This can lead to decent compression ratio. However, the generic algorithms do not exploit the characteristics of XML, which may lead to better performance in terms of compression ratio, CPU load, and memory consumption. In particular, most of the compression algorithms requires relatively large amount of memory.

Many XML specific compression algorithms have been developed to further improve compression performance over the generic algorithms. A few of them are:

XMill (H. Liefke and D. Suciu: “Xmill: an Efficient Compressor for XML Data”, Proceedings of the 2000 ACM SIGMOD International Conference on Management of Data, pages 153-164, May 2000). It is based on three principles: separating structure (tags and attributes) from data, grouping related data items into containers, and applying semantic (i.e. specialized) compressors to different containers. XMill shows improvements on compression ratio over gzip, at roughly the same speed. However, it has certain limitations: a) not suitable for on-the-fly compression since it needs restructuring data in the original XML documents into multiple containers before applying gzip; b) performs worse than gzip for small (<20 KB) XML documents, therefore not useful for XML messaging which typically involves small-sized XML documents; c) requires large amount of memory, e.g., 8 MB by default for each container; d) semantic compressors require human interaction; e) compressed data cannot be queried without decompressing it first.

XGRIND (P. M. Tolani and J. R. Haritsa: “XGRIND: A Query-friendly XML Compressor”, Proceedings of the 18^{th} International Conference on Data Engineering, February 2002) and XPRESS (J.-K. Min, M.-J. Park, and C.-W. Chung: “XPRESS: A Queriable Compression for XML Data”, Proceedings of the 2003 ACM SIGMOD International Conference on Management of Data, pages 122-133, June 2003). Both are designed to be query friendly. XPRESS improves over XGRIND by the use of reverse arithmetic encoding for tags (instead of dictionary coding) and type specific encoding for data values. However, they have drawbacks: a) XGRIND requires DTD (Document Type Declaration) to identify enumerated-type attributes; b) Both XGRIND and XPRESS require two scans over the original XML document: first scan to collect statistics of the document and the second one to compress. This means it is not suitable for online compression; d) Slow compression speed, mainly due to the two scan approach.

WBXML (Binary XML Content Format Specification, Version 1.3, 25 July 2001. Wireless Application Protocol). This specification defines a binary representation of the XML. Basically, the encoder tokenises an XML document based on its structure. Its drawbacks are: a) lossy compression: all comments, the XML declaration, and the document type declaration will not be preserved during compression (they must be removed); b) requires at least two-pass compression since the string table precedes the tokenised document body, which needs to refer to the string table. This slows down compression and also means it is not suitable for online compression; c) not flexible to handle future changes of XML; d) white space characters are not compressed.

Moreover, the US patent application No. 2002 0065822 discloses a structured document compressing scheme in which a plurality of structured documents having a common data structure are compressed using a single tag list. The compressor has to know in advance that a document has the same structure as the tag list. Thus, this compressing scheme has limited applicability. Furthermore, two passes are required if the compressor does not know the document structure in advance. All tags in an XML document are extracted and put into a tag list. The compressor sends the tag list separately, in addition to the compressed XML document. In addition, it is assumed that tags in a document appear in the exactly same order as in the tag list. Otherwise, compression will be lossy.

Furthermore, in the Japanese laid-open application No. 2003 157249 A a document compressing and storing method is described. A compression result index (CRX) which specifies the relation between a node, original component and document identifiers assigned to portions corresponding to each node of a schema of an extensible markup language (XML) document is formed and stored in an XML database. A compression result set (CRS) is formed by setting a group of component identifiers corresponding to the stored CRX.

### SUMMARY OF THE INVENTION

It is an object of the present invention to provide an improved compression/decompression scheme for structured documents which is fast and has low memory consumption.

The invention introduces a compression method for structured documents, such as XML and HTML documents (i.e. documents having a Markup Language characteristic), that is fast and has low memory consumption. The compressed document can be created such that it is human readable. The compression method is adaptive, i.e. it does not require any prior knowledge of DTD (Document Type Declaration) or XML schema for the XML document. In addition, it requires only one pass over the original XML document and is therefore suitable for online compression. The idea is that the encoder parses an XML document and builds levelled dictionaries on-the-fly for element tags and optionally character data in element content. The dictionaries are used to compress subsequent element tags and content at the corresponding level within the same scan. The dictionaries are implicitly transmitted in the compressed document so that the decoder can rebuild the levelled dictionaries and decompress the compressed document.

The compression scheme according to the invention is adaptive, i.e. no prior knowledge about the input XML document is assumed. In particular, it does not depend on the prior knowledge of the document grammar that is described with either DTD (Document Type Declaration) or XML Schema. The single-pass supports online compression since there is no need to buffer the entire XML document.

According to the present invention, a much faster compression speed and less memory consumption compared with existing algorithms is achieved due to the levelled dictionary approach and focus on element tags. This is particularly useful for mobile devices which usually have limited resources. It also helps the scalability of servers that support XML document compression.

There is a good compression performance for small (e.g. <20 KB) XML documents, which are the most typical ones occurring in web browsing. In addition, the core procedures of the invention are easier to implement than existing techniques. The compression algorithm of the present invention can be easily combined with generic data compression algorithms to achieve high compression ratio.

The compression scheme is homomorphic, i.e. preserves the structure of the original XML data in compressed data. This allows direct query on compressed XML data.

### BRIEF DESCRIPTION OF THE DRAWINGS

FIG. 1 shows a flow chart illustrating a compression method according to an embodiment of the invention.

FIG. 2 shows a flow chart illustrating part of a flow in FIG. 1 in greater detail.

FIG. 3 shows a flow chart illustrating a decompression method according to an embodiment of the invention.

FIG. 4 shows a schematic block diagram illustrating a compression apparatus according to an embodiment of the invention.

FIG. 5 shows a schematic block diagram illustrating a decompression apparatus according to an embodiment of the invention.

FIG. 6 shows an example of an XML document structure.

FIG. 7 shows a logical view of the XML document example of FIG. 6.

FIG. 8 shows dictionaries at different levels which are formed from the XML document example according to the compression scheme of the invention.

FIG. 9 shows a compressed XML document generated from the XML document example according to the compression scheme of the invention.

FIG. 10 shows dictionaries reconstructed from the compressed XML document according to the decompression scheme of the invention.

### DESCRIPTION OF THE INVENTION

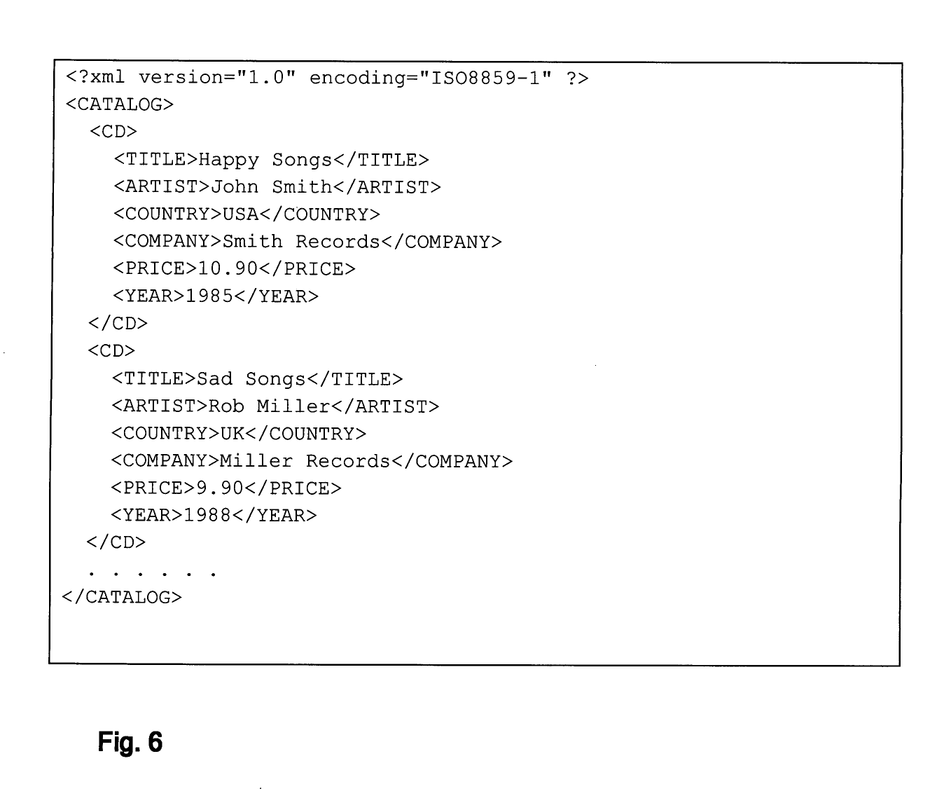

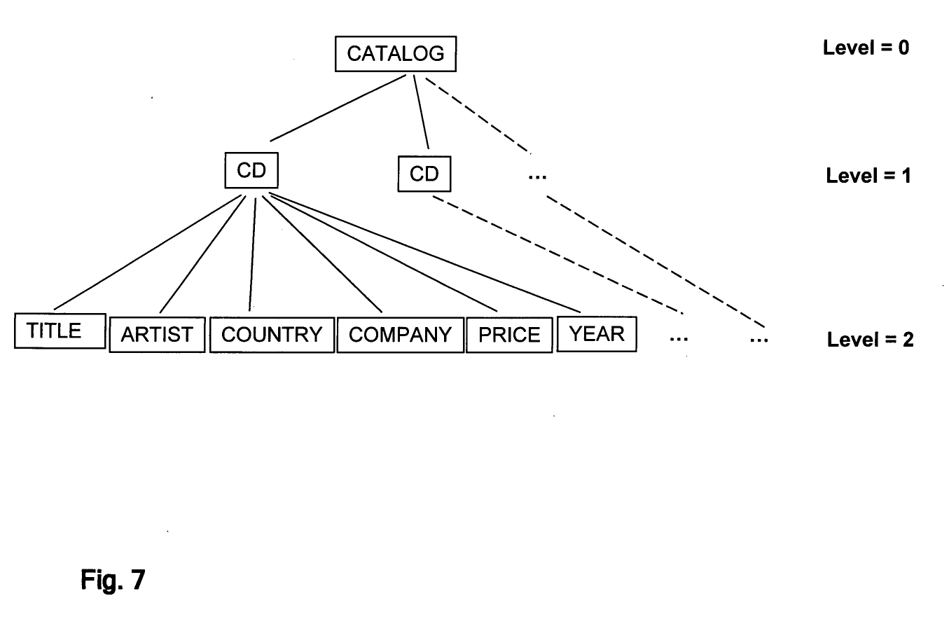

As shown in FIG. 7, logically all the elements in an XML document are organized in a tree structure. There is only one root element per XML document. According to the example shown in FIG. 6 CATALOG is the root element. The root element contains its child elements (CD in the example), and the child elements in turn contain their own child elements (TITLE, ARTIST, COUNTRY, COMPANY, PRICE, YEAR), and so on.

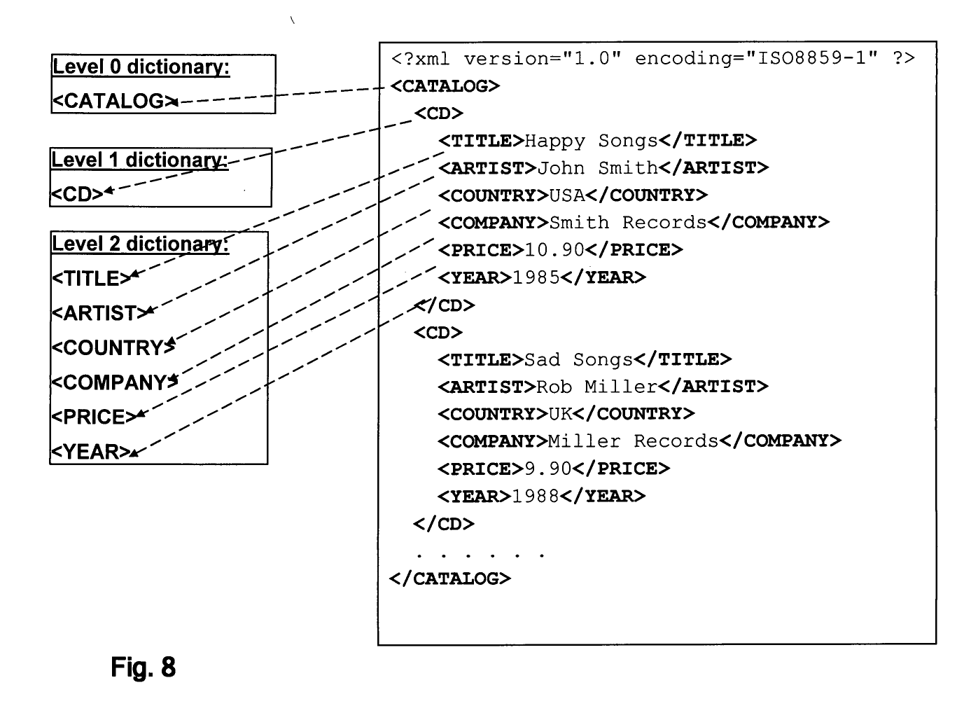

According to the invention, level numbers are assigned to the elements (i.e. nodes) in the tree. Thus, the root element has level 0, children of the root element have level 1, etc. This tree structure is utilized to generate different dictionaries for elements at different levels and compress an element only with the dictionary at its level. FIG. 8 shows the dictionaries at different levels formed from the XML document example of FIG. 6. The forming of dictionaries individually for each level in a structured document will be described in greater detail below.

It is to be noted that XML is only an example of applicable formats. The invention is similarly applicable to other formats having Markup Language characteristic.

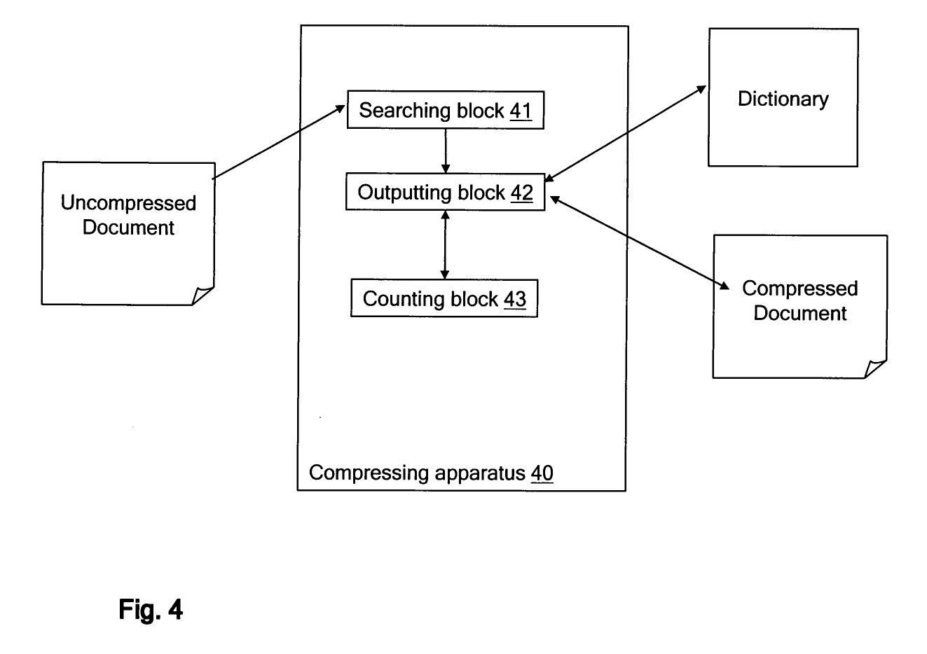

Initially, a compressor such as a compressing apparatus 40 shown in FIG. 4 sets a dictionary set as empty. It also sets a parameter current_level to 0. Then, the compressor linearly scans an XML document. It is to be noted that the compressor only needs a single pass through the document.

When the compressor encounters a start-tag, e.g. <CATALOG>as shown in FIG. 8, the compressor will search the start-tag in the dictionary at current_level. If match is found, a reference to the dictionary at current_level is output. If no match is found, the start-tag is added to the dictionary at current_level and the tag is output uncompressed. In either case, the parameter current_level is incremented.

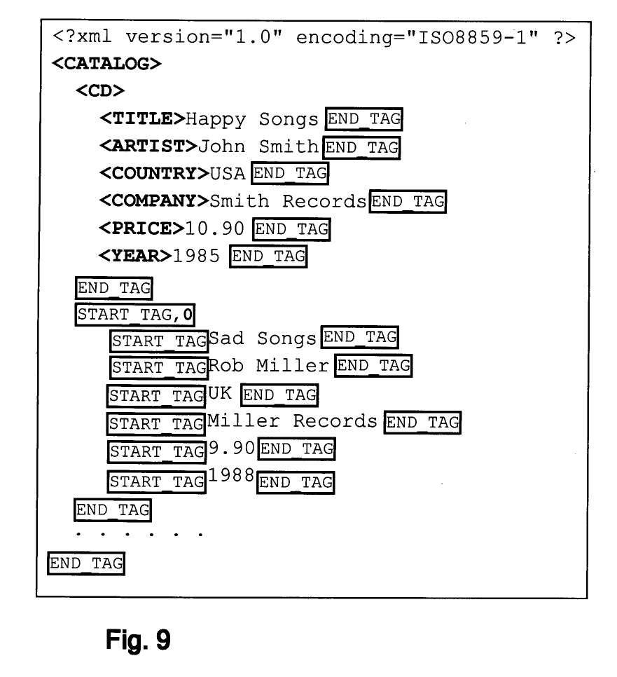

As shown in FIG. 8, <CATALOG> is added to level 0 dictionary, and the <CATALOG> is output uncompressed as shown in FIG. 9. Then, a start-tag <CD> is encountered. Since also <CD> is encountered for the first time, i.e. no corresponding entry is in the dictionary at current_level, i.e. at level 1, <CD> is added to level 1 dictionary and is output uncompressed, as shown in FIG. 9 illustrating a compressed XML document generated from the XML document example of FIG. 6. The parameter current_level is incremented and scanning is continued. Then, a start-tag <TITLE> is encountered. Since there is no match found in the dictionary at current_level, i.e. level 2, <TITLE> is added to level 2 dictionary, output uncompressed as shown in FIG. 9 and the parameter current_level is incremented.

When the compressor encounters an end-tag, the compressor outputs a special codeword to signal the end of current element and decrements the parameter current_level. It is to be noted that end-tags will not be added to dictionaries, since they can be derived from the corresponding start-tags by a decompressor.

As shown in FIG. 8, after <TITLE> the compressor encounters and end-tag </TITLE>. A special codeword is output, e.g. “END_TAG” as shown in FIG. 9, and the parameter current_level is decremented.

Thus, when a next start-tag is encountered, e.g. <ARTIST> as shown in FIG. 8, since no match is found in the dictionary at current_level i.e. level 2, <ARTIST> is added to level 2 dictionary and is output uncompressed as shown in FIG. 9.

In case a match is found in the dictionary at current_level, e.g. when the start-tags <CD> and <TITLE> are encountered for the second time as shown in FIG. 8, a reference to the dictionary is output as shown in FIG. 9.

As an option, the compressor may pre-populate the dictionaries even before the compression if it has knowledge of the XML document to be compressed.

As can be seen from FIG. 9, no separate dictionaries are generated. They are “embedded” in the compressed XML document. START_TAG and END_TAG are special codewords (or signals) for compression. In implementation, they can be chosen to have values that cannot appear in the alphabet of XML. There is no need to indicate current_level of a START_TAG since the decompressor can derive it. Usually, an index after START_TAG is used to indicate which entry in the dictionary (at current_level) corresponds to a current start-tag. According to the example, (START_TAG,0) refers to “<CD>” the level of which is 1, index=0. However, it can be omitted if the position of the current start-tag being compressed is the same as the start-tag in the dictionary. For example, START_TAG corresponding to <TITLE>, <ARTIST>, etc.

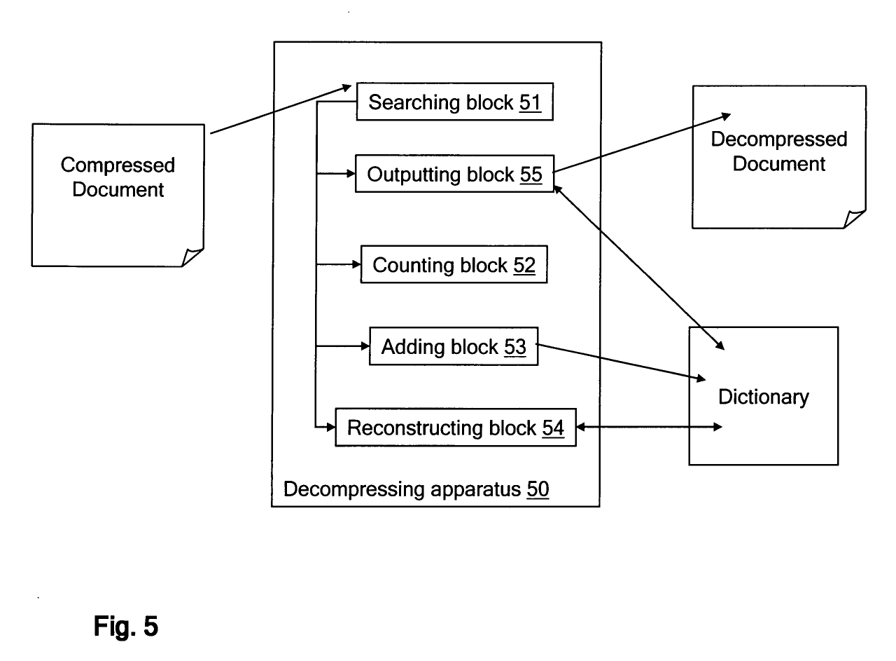

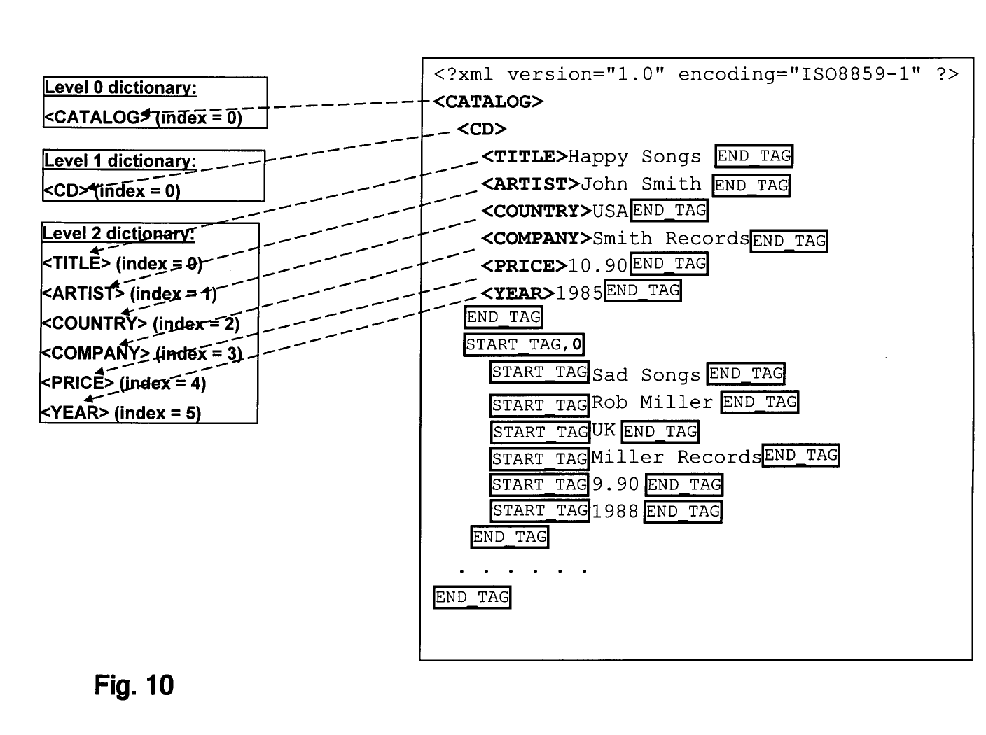

A decompressor such as a decompressing apparatus 50 shown in FIG. 5 essentially performs the inverse operations of the compressor which will be described below with reference to FIG. 10.

Initially, the decompressor sets a dictionary set as empty. It also sets a parameter current_level to 0. It then linearly scans a received compressed XML document. It tracks the current_level in the same way as the compressor, i.e. increments or decrements after encountering start-tags and end-tags.

When encountering an uncompressed start-tag, the decompressor copies it to the output, and adds it to the dictionary at current_level. In this way, the decompressor can reconstruct the exactly same dictionaries as the compressor as can be seen from FIGS. 9 and 10. When encountering a compressed start-tag, the decompressor copies a corresponding tag in the dictionary to the output.

When encountering an end-tag codeword, the decompressor reconstructs and outputs the end-tag based on the most recent start-tag it has processed at the same level. For other uncompressed data, according to the example the decompressor copies it directly to the output.

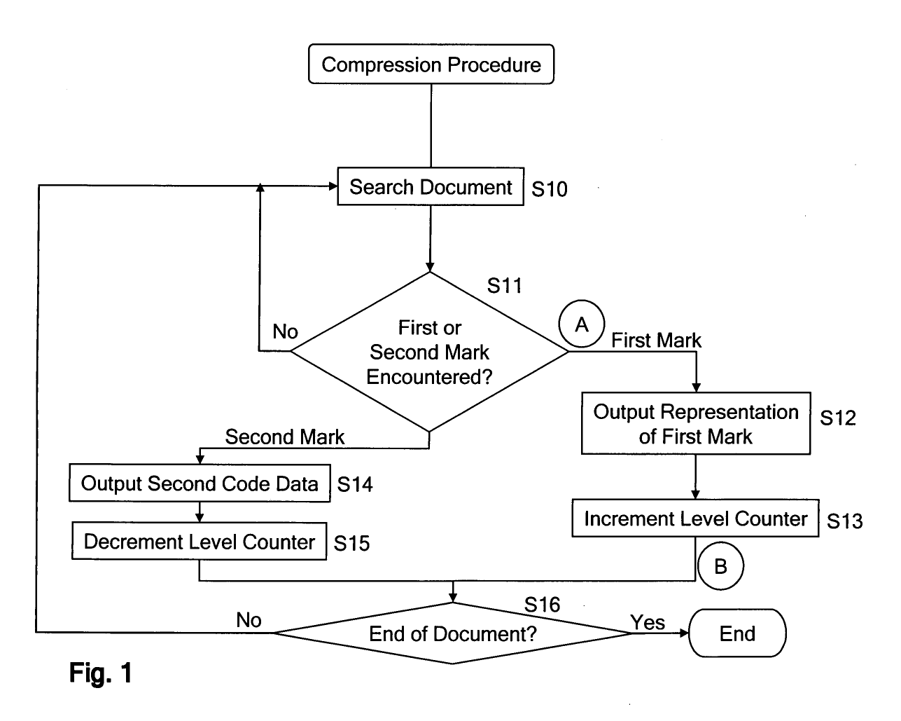

FIG. 1 shows a flow chart illustrating the above-described compression procedure according to an embodiment of the invention.

In a searching step S10 a structured document such as an XML document is searched once, e.g. from the beginning to the end of the structured document, for first and second marks, a first mark indicating a start of an element of the structured document, and a second mark indicating an end of an element of the structured document. Assuming the above example, a start-tag is a first mark and an end-tag is a second mark.

When encountering a first mark in the searching step (“first mark” in step S11), a representation of the first mark is output (step S12) and a level counter is incremented (step S13), a value of the level counter indicating on which level in the structured document an element is located. The representation of the first mark may be the first mark uncompressed or a reference to the uncompressed first mark.

When encountering a second mark in the searching step (“second mark” in step S11), a second code data is output (step S14) and the level counter is decremented (step 15). In step S16 it is checked whether the documents has been searched once. If not, the procedure returns to step S10 and searching is continued.

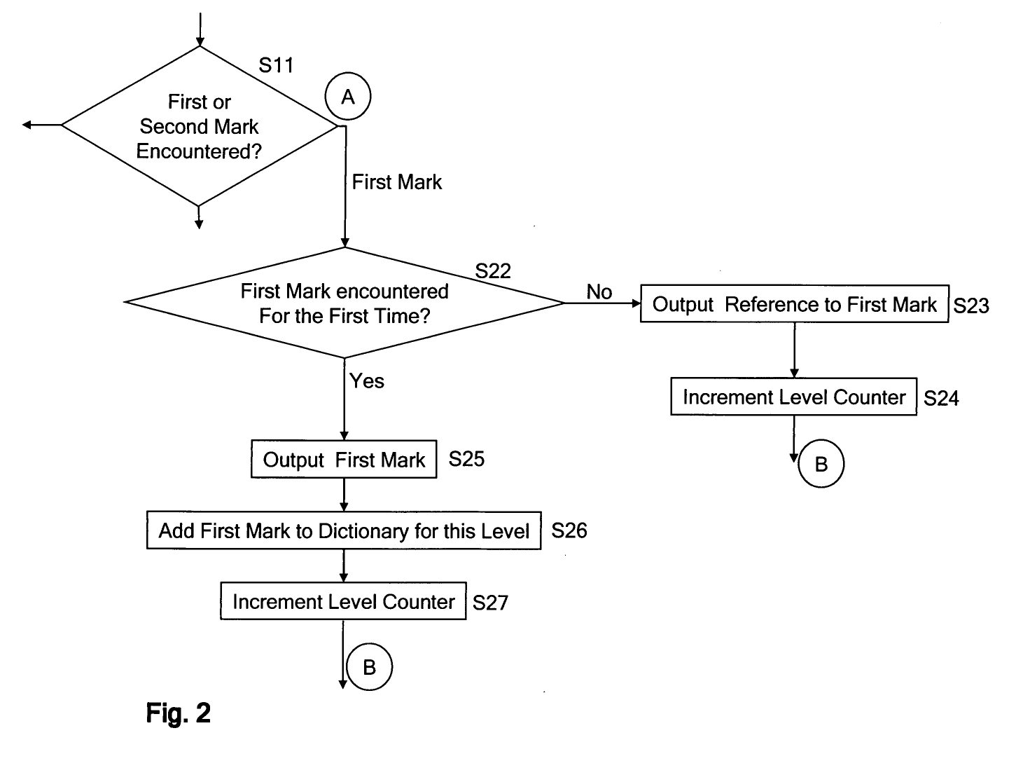

As shown in FIG. 2 illustrating in greater detail the procedure between A: encountering a first mark, and B: incrementing the level counter, when a first mark is encountered for the first time (yes in step S22), the representation of the first mark is the first mark, i.e. the first mark is output uncompressed (step S25). When a first mark is encountered for the second or following times (no in step S22), the representation of the first mark is a reference to the representation of the first mark output when the first mark is encountered for the first time. This reference is output in step S23. Considering FIGS. 8 and 9, the reference of <CD> encountered for the second time is a reference to the dictionary embedded in the compressed documents, i.e. a reference to the uncompressed output <CD>. After steps S27 and S24, respectively, the level counter is incremented. For speeding up determination of whether a first mark appears for the first time or not, a level of the first mark and an order of the first mark within the level of the structured document may be used for determining whether the first mark is encountered for the first time or not.

Moreover, as shown with respect to FIGS. 8 and 9, representations of first marks encountered for the first time form a dictionary, wherein the dictionary is formed individually for each level of the structured document.

A representation of a first mark encountered for the second or following times is a first code data, such as “START_TAG”.

The first code data may comprise an index, a value of the index indicating an order of the first marks within a level of the structured document.

In the searching step searching may be carried out also for elements in the structured document. When encountering a content of an element for the first time in the searching step, the content of the element is output as it is, and when encountering the content of the element for the second or following times in the searching step, a reference to the content of the element output when the content of the element is encountered for the first time is output, thereby forming a dictionary individually for each level of the structured document.

The element may comprise at least one of the types of character data, comments and processing instructions. The first and second code data may be provided for each type of elements separately.

Moreover, in the searching step searching for specific marks such as an empty element mark in the structured document may be carried out, wherein when encountering a specific mark, a specific code data is output.

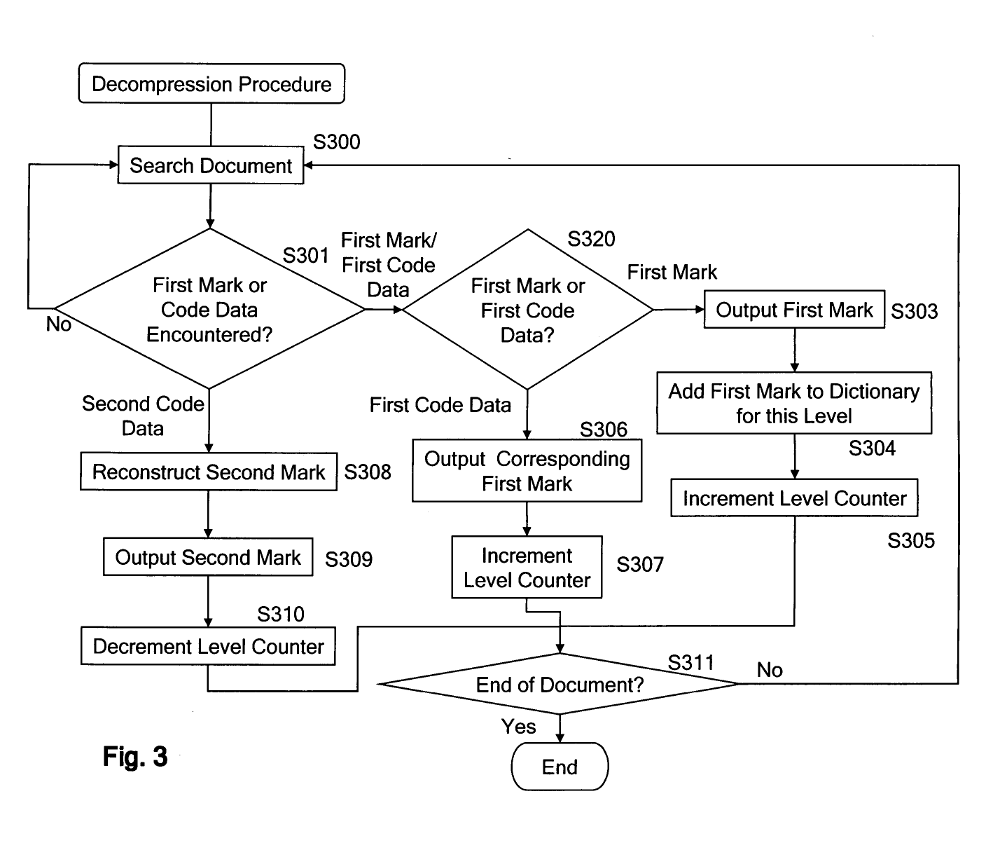

FIG. 3 shows a flow chart illustrating the above-described decompression procedure according to an embodiment of the invention. When decompressing a compressed structured document, such as an XML document, comprising representations of first marks, the representations including uncompressed first marks and first code data, and second code data representing second marks, a first mark indicating a start of an element of the structured document, and a second mark indicating an end of an element of the structured document, the compressed structured document is searched (step S300) once, e.g. from the beginning to the end of the compressed structured document, for representations of first marks and second code data.

When encountering an uncompressed first mark in the searching step (“first mark” in steps S301 and S320), the uncompressed first mark is output (step S303), the uncompressed first mark is added to a dictionary (step S304), and a level counter is incremented (step S305), a value of the level counter indicating on which level in the compressed structured document an element is located, thereby forming the dictionary individually for each level of the compressed structured document.

When encountering a first code data in the searching step (“first code data” in step S320), a corresponding uncompressed first mark is output from the dictionary of the corresponding level (step S306) and the level counter is incremented (step S307).

When encountering the second code data in the searching step (“second code data” in step S301), a second mark is reconstructed (step S308), the second mark is output (step S309) and the level counter is decremented (step S310).

The corresponding uncompressed first mark may be searched in the dictionary using a value of an index included in the first code data, the value of the index indicating an order of the first marks within a level of the structured document.

Furthermore, the searching step may comprise searching for elements and references to elements in the compressed structured document. In this case, when encountering an uncompressed content of an element in the searching step, the content of the element is output as it is and the content of the element is added to the dictionary, and when encountering a reference to an element in the searching step, a corresponding content of the element is output from the dictionary.

FIG. 4 shows a schematic block diagram illustrating an apparatus for compressing a structured document according to an embodiment of the invention. The apparatus comprises a searching block 41, an outputting block 42 and a counting block 43. The searching block 41 searches a structured uncompressed document once for first and second marks.

When a first mark is encountered by the searching block 41, the outputting block 42 outputs a representation of the first mark, and the counting block 43 increments a level counter, a value of the level counter indicating on which level in the structured document an element is located.

When a second mark is encountered by the searching block 41, the outputting block 42 outputs a second code data, and the counting block 43 decrements the level counter. Data or signals output from the outputting block form a compressed document.

When a first mark is encountered by the searching block 41 for the first time, the outputting block 42 may output the first mark. When a first mark is encountered by the searching block 41 for the second or following times, the outputting block 42 may output a reference to the representation of the first mark output when the first mark is encountered for the first time. For this purpose, a local dictionary may be formed as shown in FIG. 4 so that the outputting block 42 can compare a current first mark against the dictionary at current level. Of course, the dictionary is only used locally for compression. It is not part of the compressed document. Alternatively, the outputting block 42 may access the compressed document for the comparing operation.

The outputting block 42 may output as a representation of a first mark encountered for the second or following times a first code data and add an index to the first code data, a value of the index indicating an order of the first marks within a level of the structured document.

The searching block 41 may search for elements in the structured document, wherein when a content of an element is encountered for the first time, the outputting block 42 may output the content of the element as it is, and when the content of the element is encountered for the second or following times, the outputting block may output a reference to the content of the element output when the content of the element is encountered for the first time, thereby forming a dictionary individually for each level of the structured document.

The searching block 41 may search for specific marks in the structured document, wherein when a specific mark is encountered, the outputting block 42 may output a specific code data.

According to the compressing apparatus 40, the searching block 41 accesses the uncompressed document and gathers specific data from the uncompressed document. The outputting block 42 outputs data to form the compressed document, but may also access the compressed document and gather data therefrom. The outputting block 42 receives gathered data, e.g. the start-tags and end-tags, from the searching block 41, and level information from the counting block 43 and processes the received data on the basis of the level information using the data already output to the compressed document.

FIG. 5 shows a schematic block diagram illustrating an apparatus for decompressing a compressed structured document according to an embodiment of the invention. The compressed structured document comprises representations of first marks, the representations including uncompressed first marks and first code data, and second code data representing second marks, a first mark indicating a start of an element of the structured document, and a second mark indicating an end of an element of the structured document. The apparatus comprises a searching block 51, a counting block 52, an adding block 53, a reconstructing block 54 and an outputting block 55.

The searching block 51 searches the compressed structured document once for representations of first marks and second code data.

When an uncompressed first mark is encountered by the searching block 51, the adding block 53 adds the uncompressed first mark to a dictionary, thereby forming the dictionary individually for each level of the compressed structured document. In addition, the outputting block 55 outputs the uncompressed first mark, and the counting block 52 increments a level counter, a value of the level counter indicating on which level in the compressed structured document an element is located.

When a first code data is encountered by the searching block 51, the outputting block 55 outputs a corresponding uncompressed first mark from the dictionary of the corresponding level, and the counting block 52 increments the level counter.

When a second code data is encountered by the searching block 51, the reconstructing block 54 reconstructs a second mark, the outputting block 55 outputs the second mark reconstructed by the reconstructing means, and the counting block 52 decrements the level counter.

The outputting block 55 may search the corresponding uncompressed first mark in the dictionary using a value of an index included in the first code data, the value of the index indicating an order of the first marks within a level of the structured document.

The searching block 51 may search for elements and references to elements in the compressed structured document, wherein when an uncompressed content of an element is encountered by the searching block 51, the outputting block 55 may output the content of the element as it is and the adding block 53 may add the content of the element to the dictionary, and

when a reference to an element is encountered by the searching block 51, the outputting block may output a corresponding content of the element from the dictionary.

According to the decompressing apparatus 50 in FIG. 5, the searching block accesses a compressed document and gathers specific data therefrom. The outputting block 55 outputs data to form a decompressed document. A dictionary is generated by the adding block 53. The outputting block 55 processes data received from the searching block 51 on the basis of level information received from the counting block using the dictionary and outputs the processed data to form the decompressed document. The reconstructing block 54 uses level information and the dictionary for reconstructing data which then are output by the outputting block 55 to form the decompressed document.

It is to be noted that FIGS. A4 and A5 illustrate parts of a compressor and decompressor which serve to explain the compression scheme of the present invention. The compressing apparatus 40 and the decompressing apparatus 50 may of course comprise further parts. Moreover, blocks in FIGS. A4 and A5 may be grouped together or may be further split into subblocks.

The present invention may also be achieved by a computer program and a signal carrying processor implementable instructions.

As described above, the key idea of the invention is to exploit the tree structure of elements in an XML document so that a compressor can build on-the-fly a levelled set of dictionaries for marks or element tags (i.e. names and attributes). In particular, the compressor tracks the level of a current element to be compressed and compresses the element tags using only the dictionary at the corresponding level. Since element names/attributes at the same level will be likely to repeat, the compressor spends less time on string match than generic algorithms. In addition, since element tags are usually the most redundant parts of an XML document (see example in FIG. 6), this invention requires only a very small amount of memory (for the storage of dictionaries) and CPU time to achieve a good compression ratio.

In the following, operations of a compressor such as the compressing apparatus 40 and decompressor such as the decompressing apparatus 50 are described in accordance with an implementation example of the invention.

Compression Procedures

The compressor maintains a counter to track a current level of an element, which is referred to as current_level or cur_level. In the beginning of the compression procedure, cur_level is initialized to 0 (zero). Also, there are no dictionaries for element tags initially.

For a given XML document, the compressor linearly parses the XML document for the beginning (i.e. start-tag) and ending (i.e. end-tag) of a new element. If a start-tag is encountered, the compressor compresses it against the tag dictionary of cur_level, which is referred to as tag_dict[cur_level]. This basically involves a search for matched strings between the current tag and tag_dict[cur_level]. A matched string is encoded with a reference to the string in tag_dict[cur_level]. An unmatched string is output by the compressor uncompressed and added to tag_dict[cur_level]. A compressed start-tag will begin with a special codeword START_TAG, followed by a sequence of encoded matched and/or unmatched strings. Note that the value of cur_level does not need to be explicitly carried in the compressed start-tag because the decompressor can derive it locally (see decompression procedures). The compressor increments cur_level by 1 after compression is done.

It is to be noted that if this is the first time for the compressor to visit the level, tag_dict[cur_level] does not exist yet. The compressor creates one and updates it with the current start-tag.

If an end-tag is encountered, the compressor simply outputs a special codeword END_TAG to signal the end of the current element. The compressor does not need to output the name in the end-tag, since it is the same as that of the start-tag and the decompressor already has the start-tag decompressed. The compressor decrements cur_level by 1 after compressing the end-tag. It is to be noted that the compressor does not update tag_dict[cur_level] with end-tags. It is allowed, though rarely occurs in practice, that an end-tag may contain optional “white space” at the end that consists of one or more space characters (0x20), tabs (0x09), linefeeds (0x0A) or carriage returns (0x0D). If this is the case, the compressor can encode the end-tag by another codeword, e.g., END_TAG_EXT, followed by the length of the optional “white space” and the uncompressed “white space” itself.

If an empty-element tag is encountered, the compressor treats this as a special case of a start-tag. The operation is the same as that with the regular start-tag described above, with the following exceptions: a) the compressor does not change the cur_level (conceptually, the compressor enters an empty element and exits it right away); b) the compressor outputs a special codeword EMPTY_ELEM_TAG , which is different from START_TAG. This allows the decompressor to disambiguate between them.

There may be also cases in which tags do not have a corresponding end-tag. These tags can be handled similar to an empty-tag as described above, except that there may be a content after these tags.

In the example shown in FIG. 6, “TITLE”, “ARTIST”, etc., are all at the same level. They are “children” of element “CD”. They will be added to the tag_dict[cur_level] in the order as they appear in the input XML document. The compressor may maintain a counter of elements encountered at each level, which may be denoted as elem_count[cur_level]. The compressor sets elem_count[cur_level] to zero each time it enters cur_level from a higher level and then increment it by 1 after processing each element at cur_level. This allows the compressor to perform two optimisations. First, for string matching, the compressor can try to compare the current tag first with the tag in tag_dict[cur_level] that has an index elem_count[cur_level]. This is likely to lead to a “hit” (i.e. good match) and avoid the unnecessary comparison against other tags in tag_dict[cur_level]. The reason, as can be seen from the catalog example of FIG. 6, is that the elements at the same level tend to repeat in the same order in an XML document. In case it is a miss (i.e. no match), the compressor can then proceed to other tags at tag_dict[cur_level]. Second, the compressor may utilize this indexing scheme to have more efficient encoding. Namely, if it is a hit, the compressor does not even need to output a reference to the tag_dict[cur_level]. Instead, it can simply output a codeword START_TAG_H (a different codeword than regular START_TAG) to signal this case to the decompressor. Since the decompressor also tracks elem_count[cur_level], it can determine which start-tag in tag_dict[cur_level] is used as reference to compress the current start-tag. This allows an optimised handling of multiple elements at the same level.

The above described procedures focus on compressing element tags. They eliminate the major redundancy of markup introduced by XML (compared to general text files). Below are some optional procedures that can be implemented together with the above procedures. They may increase the overall compression ratio, but at the cost of additional memory and CPU consumption. It is an implementation decision whether or not they should be implemented.

For example, also character data (i.e. text) in element contents may be compressed. For this purpose, the compressor can also create dictionaries for character data in element contents, one dictionary for each level. A codeword is needed.

Moreover, markup other than element tags may be compressed, e.g., comments and processing instructions. The compressor can create one dictionary for all of them, or one dictionary for each type of markup, e.g., one for comments, and another one for processing instructions. The latter may reduce the string search time and thus speed up compression. A codeword is needed for each type of markup that is compressed.

In addition, sequence of spaces may be compressed. The compressor can use simple run length encoding to compress a sequence of spaces, which may occur often in some XML documents. A codeword is needed.

It is to be noted that all the above procedures are preformed in a single scan of the input XML document. This is a key difference from many existing XML compression schemes.

Moreover, the compression scheme according to the invention is adaptive. Following the above procedures, the compressor can learn and exploit the document structure on-the-fly, without any prior knowledge about the XML document, such as DTD or XML schema. This is another advantage over schema dependent compression algorithms.

Encoding Format

The output of the compressor will be a bit stream in which compressed and uncompressed units are intermingled. A compressed unit could be a compressed element tag, compressed character data in element content, a compressed comment, etc. In the following the basic principles for encoding formats are described. The exact format may vary depending on implementation.

Uncompressed characters are copied directly from the input to the output. Each compressed unit is preceded with a special codeword that does not appear in the character set of an uncompressed XML document. This is needed for the decompressor to identify a compressed unit and decode it accordingly. According to XML 1.0 specification, characters in the range of [0x00, 0x1F]—except 0x09, 0x0A and 0x0D—will not appear in an uncompressed document. Therefore, they (29 code points in total) can be used as the special codewords (e.g. START_TAG) as mentioned in the compression procedures. The exact assignment of codewords is implementation issue, as long as the compressor and decompressor agree on the assignment. Note that under UTF-8 encoding (the most common character encoding), the codewords will be represented with the exact bit pattern as their numerical values. This simplifies the implementation.

As to the end of a compressed unit, it can be either explicitly indicated by another special codeword or implicitly derived if the length of compressed unit is self-explained in the encoding of that particular unit. For example, an END_TAG codeword not only indicates the presence of an end-tag in the original XML document, but also marks the end of a current element content, whose character data (if present) may be either compressed or uncompressed.

If the optional procedures are implemented, additional codewords are needed to indicate the beginning and end of markup other than element tags. They can be assigned from the aforementioned code point space.

Regarding granularity for compressing start-tag, there are basically two cases. Case 1: it could be done at byte level, following the generic data compression algorithms. Case 2: it could be done at higher level using XML structure. Namely, the string match search is done in units of tag names, attribute names and attribute values. The extreme of Case 2 is to compress a start-tag as a whole, i.e. when it matches exactly with a tag in tag_dict[cur_level]. Case 2 allows faster compression as it generally requires less time for string matching. Also, it allows more efficient encoding for compressed start-tags. However, it may lose some compression ratio compared to Case 1. This is a tradeoff in implementation.

A line break immediately after an end-tag is typical in XML documents for the purpose of readability. A codeword END_TAG_NEWLINE can be used to encode this case. This saves bytes that are otherwise needed for the line break.

Depending on the exact structure of tag dictionaries, a compressed start-tag may require an indication of the index of a reference tag in tag_dict[cur_level]. One option is to encode the index explicitly after a START_TAG codeword. An alternative is to use several codewords for start-tags, so that each of them indicates a particular value of the index. For example, START_TAG_{—}0, START_TAG_{—}1, etc. This is particularly useful if encoding has to be byte aligned and there are codewords available to use. A more general case could be to combine this with explicit index field. Namely, 1-byte codewords are used for small index values and a separate index field is used for large index values.

Decompression Procedures

A compressed XML document is inputted to a decompressor as bit stream. The decompressor processes the compressed XML document according to the following procedures.

Similar to the compressor, the decompressor also maintains cur_level, a set of tag_dict for each level, elem_count for a current level, and any other optional dictionaries such as content dictionaries, etc. They are initialized in the same way as in the compressor. This constitutes the decompressor context.

The decompressor is able to distinguish between compressed units from uncompressed units by the codewords as described above. If an uncompressed unit is encountered, the bytes in the unit are copied directly to the output. If a compressed unit (e.g. a compressed tag) is encountered, the decompressor uses the corresponding dictionary (e.g. tag_dict[cur_level]) to decompress the unit. In addition, the decompressor updates the corresponding dictionaries (e.g. tag_dict[cur_level] and variables (e.g. cur_level, elem_count[cur_level]) in the same way as the compressor. This ensures that the decompressor context is kept in lockstep with the compressor context during decompression. In addition, this allows more efficient encoding since some context variables (e.g. cur_level, elem_count[cur_level]) do not need to be explicitly transmitted in the compressed XML document.

Implementation Notes

There may be many variations in implementation without deviating from the scope of the present invention. One reason for the variation is to find a good tradeoff between compression ratio, CPU cost, and memory consumption. In general, an implementation should start with the compression procedures focusing on compressing element tags, and use coarse granularity for string matching. This will lead to the most efficient usage of CPU and memory, since it focuses on the resources on the element tags which are the most redundant parts of XML documents. In practice, a good compression ratio can usually be achieved in this way with a very small memory footprint and CPU consumption. To go beyond this, an implementation may explore the usage of optional procedures, which may increase compression ratio at the cost of additional CPU and memory requirements.

In case the XML specifications evolves such that aforementioned codewords become a normal part of the XML character set, the scheme can be adapted by using any 1-byte characters that remain outside of the XML character set. If there are no such characters, the codewords can be mapped to 1-byte characters that are less likely to appear in a XML document. An escaping scheme is also needed for those codewords. Details are beyond the scope of this invention.

An implementation applying a compression of element tags has been tested using a small sample of XML documents. The documents have a structure similar to the one in the example of FIG. 6. For comparison, the same set of documents was also compressed with DEFLATE—a very good compression algorithm for generic data compression. Below is the result. It shows that the new scheme achieves a reasonably good compression ratio compared to DEFLATE, but only requires a fraction of cost on CPU and memory. Note that compression performance depends on the sample files. The following result should be regarded only as an example, not as a thorough analysis of the performance. Nevertheless, the test result validates the design principles of the scheme according to the present invention.

| | Scheme according to | |
|---|---|---|
| | Invention | DEFLATE |
| Savings by compression | 40%˜60% | 60˜80% |
| Memory needed for compression | 0.1 KB˜0.2 KB | 5 KB |
| Time needed for compression | 0.2˜0.3 | 1 |
| (scaled with respect to DEFLATE) | | |

It is to be understood that the above description is illustrative of the invention and is not to be construed as limiting the invention. Various modifications and applications may occur to those skilled in the art without departing from the true spirit and scope of the invention as defined by the appended claims.

1. A method of compressing a structured document, the method comprising:
a searching step of searching the structured document once for first and second marks, each first mark indicating a start of a corresponding element of the structured document, and each second mark indicating an end of the corresponding element of the structured document;
when encountering one of the first marks in the searching step, outputting a representation of the one of the first marks and incrementing a value of a level counter, wherein the value of the level counter indicates a level of the structured document in which the element is located; and
when encountering one of the second marks in the searching step, outputting a code data and decrementing the value of the level counter.

2. A method according to claim 1, wherein when encountering the one of the first marks for a first time, the representation of the one of the first marks is the one of the first marks as it is.

3. A method according to claim 1, wherein when encountering the one of the first marks for second or following times, the representation of the one of the first marks is a reference to the representation of the one of the first marks as output when the one of the first marks is encountered for a first time.

4. A method according to claim 1, wherein the representation of the one of the first marks encountered for a first time forms a dictionary, wherein the dictionary is formed individually for each level of the structured document.

5. A method according to claim 4, further comprising:
determining using the dictionary whether the one of the first marks is encountered for the first time based on the level of the one of the first marks and an order of the one of the first marks within the level.

6. A method according to claim 1, wherein the representation of the one of the first marks encountered for second or following times is a first code data and, when encountering the one of the second marks in the searching step, the code data output is a second code data.

7. A method according to claim 6, wherein the first code data comprises an index, and a value of the index indicates an order of the one of the first marks within the level of the structured document.

8. A method according to claim 1, wherein the searching step further comprises:
searching elements in the structured document; when encountering a content of one of the elements for a first time, outputting the content of the one of the elements as it is; and
when encountering the content of the one of the elements for a second or following times, outputting a reference to the content of the one of the elements, which is output when the content of the one of the elements is encountered for the first time, to form a dictionary individually for each level of the structured document.

9. A method according to claim 1, wherein the element comprises types of character data, comments, or processing instructions.

10. A method according to claim 9, wherein first and second code data are provided for each type of elements, separately.

11. A method according to claim 1, wherein the searching step further comprises:
searching specific marks in the structured document; and
when encountering one of the specific marks in the searching step, outputting a specific code data.

12. A method of decompressing a compressed structured document comprising representations of first marks, wherein the representations include the first marks and first code data, and second code data representing second marks, and each first mark indicates a start of a corresponding element of the compressed structured document, and each second mark indicates an end of the corresponding element of the compressed structured document, the method comprising:
a searching step of searching the compressed structured document once for representations of the first marks and the second code data;
when encountering each of the first marks in the searching step, outputting each of the first marks, adding each of the first marks to a dictionary, and incrementing a value of a level counter, wherein the value of the level counter indicates a level of the compressed structured document in which the corresponding element is located to form the dictionary individually for each level of the compressed structured document;
when encountering the first code data in the searching step, outputting a corresponding first mark from the dictionary of a corresponding level and incrementing the value of the level counter; and
when encountering the second code data in the searching step, reconstructing a corresponding second mark, outputting the corresponding second mark and decrementing the value of the level counter.

13. A method according to claim 12, wherein the corresponding first mark is searched in the dictionary using a value of an index included in the first code data, the value of the index indicating an order of the first marks within each level of the structured document.

14. A method according to claim 12, wherein the searching step further comprises:
searching elements and references to the elements in the compressed structured document;
when encountering a corresponding content of one of the elements, outputting the corresponding content of the one of the elements as it is and adding the corresponding content of the one of the elements to the dictionary; and
when encountering a reference to the one of the elements, outputting the corresponding content of the one of the elements from the dictionary.

15. An apparatus for compressing a structured document, the apparatus comprising:
searching means for searching the structured document once for first and second marks, each first mark indicating a start of a corresponding element of the structured document, and each second mark indicating an end of the corresponding element of the structured document;
outputting means for, when one of the first marks is encountered by the searching means, outputting a representation of the one of the first marks, and for, when one of the second marks is encountered by the searching means, outputting a code data; and
counting means for, when the one of the first marks is encountered by the searching means, incrementing a value of a level counter, wherein the value of the level counter indicates a level of the structured document in which the element is located, and for, when the one of the second marks is encountered by the searching means, decrementing the value of the level counter.

16. An apparatus according to claim 15, wherein when the one of the first marks is encountered by the searching means for a first time, the outputting means is configured to output the one of the first marks as it is.

17. The apparatus according to claim 16, wherein
the representation of the one of the first marks encountered for the first time forms a dictionary, wherein the dictionary is formed individually for each level of the structured document, and
when encountering the one of the first marks by the searching means, using the dictionary, the outputting means is configured to determine whether the one of the first marks is encountered for the first time based on the level of the one of the first marks and an order of the one of the first marks within the level.

18. An apparatus according to claim 15, wherein when the one of the first marks is encountered by the searching means for second or following times, the outputting means is configured to output a reference to the representation of the one of the first marks as output when the one of the first marks is encountered for the first time.,

19. An apparatus according to claim 15, wherein
the outputting means is configured to output, as a representation of the one of the first marks encountered for second or following times, a first code data and to add an index to the first code data, and a value of the index indicates an order of the one of the first marks within the level of the structured document, and
when encountering the one of the second marks, the code data output by the outputting means is a second code data.

20. An apparatus according to claim 15, wherein
the searching means is configured to search for elements in the structured document, and
when a content of one of the elements is encountered for the first time by the searching means, the outputting means is configured to output the content of the one of the elements as it is, and
when the content of the one of the elements is encountered by the searching means for the second or following times, the outputting means is configured to output a reference to the content of the one of the elements, which is output when the content of the element is encountered for the first time to form a dictionary individually for each level of the structured document.

21. An apparatus according to claim 15, the searching means being configured to search for specific marks in the structured document, wherein
when one of the specific marks is encountered by the searching means, the outputting means is configured to output a specific code data.

22. An apparatus for decompressing a compressed structured document comprising representations of first marks, wherein the representations include the first marks and first code data, and second code data representing second marks, each first mark indicates a start of a corresponding element of the compressed structured document, and each second mark indicates an end of the corresponding element of the compressed structured document, the apparatus comprising:
searching means for searching the compressed structured document once for representations of the first marks and the second code data;
counting means for, when each of the first marks is encountered by the searching means, incrementing a value of a level counter, when the first code data is encountered by the searching means, incrementing the value of the level counter, and when the second code data is encountered by the searching means, decrementing the value of the level counter, wherein the value of the level counter indicates a level of the compressed structured document in which the corresponding element is located;
adding means for, when each of the first marks is encountered by the searching means, adding each of the first marks to a dictionary to form the dictionary individually for each level of the compressed structured document;
reconstructing means for, when the second code data is encountered by the searching means, reconstructing a corresponding second mark; and
outputting means for, when each of the first marks is encountered by the searching means, outputting each of the first marks, when the first code data is encountered by the searching means, outputting a corresponding first mark from the dictionary of a corresponding level, and when the second code data is encountered by the searching means, outputting the corresponding second mark reconstructed by the reconstructing means.

23. An apparatus according to claim 22, wherein the outputting means is configured to search the corresponding first mark in the dictionary using a value of an index included in the first code data, the value of the index indicating an order of the first marks within each level of the structured document.

24. An apparatus according to claim 22, wherein
the searching means is arranged to search for elements and references to the elements in the compressed structured document,
when a corresponding content of one of the elements is encountered by the searching means, the outputting means is configured to output the corresponding content of the one of the elements as it is and the adding means is configured to add the corresponding content of the one of the elements to the dictionary, and
when a reference to the one of the elements is encountered by the searching means, the outputting means is configured to output the corresponding content of the one of the elements from the dictionary.

25. A computer program comprising processor-implementable instructions for performing a method of compressing a structured document, the method comprising:
a searching step of searching the structured document once for first and second marks, each first mark indicating a start of a corresponding element of the structured document, and each second mark indicating an end of the corresponding element of the structured document;
when encountering one of the first marks in the searching step, outputting a representation of the one of the first marks and incrementing a value of a level counter, wherein the value of the level counter indicates a level of the structured document in which the element is located; and
when encountering one of the second marks in the searching step, outputting a code data and decrementing the value of the level counter.

26. A computer program comprising processor-implementable instructions for performing a method of decompressing a compressed structured document comprising representations of first marks, wherein the representations include the first marks and first code data, and second code data representing second marks, and each first mark indicates a start of a corresponding element of the compressed structured document, and each second mark indicates an end of the corresponding element of the compressed structured document, the method comprising:
a searching step of searching the compressed structured document once for representations of the first marks and the second code data;
when encountering each of the first marks in the searching step, outputting each of the first marks, adding each of the first marks to a dictionary, and incrementing a value of a level counter, wherein the value of the level counter indicates a level of the compressed structured document in which the corresponding element is located to form the dictionary individually for each level of the compressed structured document;
when encountering the first code data in the searching step, outputting a corresponding first mark from the dictionary of a corresponding level and incrementing the value of the level counter; and
when encountering the second code data in the searching step, reconstructing a corresponding second mark, outputting the corresponding second mark and decrementing the value of the level counter.

27. A computer software medium storing a computer program comprising processor-implementable instructions for performing a method of compressing a structured document, the method comprising:
a searching step of searching the structured document once for first and second marks, each first mark indicating a start of a corresponding element of the structured document, and each second mark indicating an end of the corresponding element of the structured document;
when encountering one of the first marks in the searching step, outputting a representation of the one of the first marks and incrementing a value of a level counter, wherein the value of the level counter indicates a level of the structured document in which the element is located; and
when encountering one of the second marks in the searching step, outputting a code data and decrementing the value of the level counter.

28. A computer software medium storing a computer program comprising processor-implementable instructions for performing a method of decompressing a compressed structured document comprising representations of first marks, wherein the representations include the first marks and first code data, and second code data representing second marks, and each first mark indicates a start of a corresponding element of the compressed structured document, and each second mark indicates an end of the corresponding element of the compressed structured document, the method comprising:
a searching step of searching the compressed structured document once for representations of the first marks and the second code data;
when encountering each of the first marks in the searching step, outputting each of the first marks, adding each of the first marks to a dictionary, and incrementing a value of a level counter, wherein the value of the level counter indicates a level of the compressed structured document in which the corresponding element is located to form the dictionary individually for each level of the compressed structured document;
when encountering the first code data in the searching step, outputting a corresponding first mark from the dictionary of a corresponding level and incrementing the value of the level counter; and
when encountering the second code data in the searching step, reconstructing a corresponding second mark, outputting the corresponding second mark and decrementing the value of the level counter.

29. A signal carrying processor implementable instructions for controlling a computer to carry out a method of compressing a structured document, the method comprising: a searching step of searching the structured document once for first and second marks, each first mark indicating a start of a corresponding element of the structured document, and each second mark indicating an end of the corresponding element of the structured document;
when encountering one of the first marks in the searching step, outputting a representation of the one of the first marks and incrementing a value of a level counter, wherein the value of the level counter indicates a level of the structured document in which the element is located; and
when encountering one of the second marks in the searching step, outputting a code data and decrementing the value of the level counter.

30. A signal carrying processor implementable instructions for controlling a computer to carry out a method of decompressing a compressed structured document comprising representations of first marks, wherein the representations include the first marks and first code data, and second code data representing second marks, and each first mark indicates a start of a corresponding element of the compressed structured document, and each second mark indicates an end of the corresponding element of the compressed structured document, the method comprising:
a searching step of searching the compressed structured document once for representations of the first marks and the second code data;
when encountering each of the first marks in the searching step, outputting each of the first marks, adding each of the first marks to a dictionary, and incrementing a value of a level counter, wherein the value of the level counter indicates a level of the compressed structured document in which the corresponding element is located to form the dictionary individually for each level of the compressed structured document;
when encountering the first code data in the searching step, outputting a corresponding first mark from the dictionary of a corresponding level and incrementing the value of the level counter; and
when encountering the second code data in the searching step, reconstructing a corresponding second mark, outputting the corresponding second mark and decrementing the value of the level counter.
